(19) United States
(12) Patent Application Publication
(10) Pub. No.: US 2003/0047328 A1
(43) Pub. Date: Mar. 13, 2003

(54) Automatic, pyrotechic fire extinguisher

(76) Inventor: Domenico Piatti, Pomigliano d'Arco (IT)

Correspondence Address: Striker Striker & Stenby, 103 East Neck Road, Huntington, NY, 11743, US

(21) Appl. No.: 10/168,573

(22) PCT Filed: Dec. 19, 2000
(86) PCT No.: PCT/IT00/00533

(30) Foreign Application Priority Data
Dec. 23, 1999 (IT) NA99A000070

(51) Int. Cl. A62C 3/07

(52) U.S. Cl. 169/62; 169/71

(57) ABSTRACT

A fire extinguisher for automotive vehicles, boats, and technical environments which is either automatically controlled, in case of fire, by the action of a thermosensitive cable or, in case of front impact, by the action of a percussion pin switch or manually by a push button located in the interior compartment. It consists of a cylindrical cell box, a valve assembly, a pyrotechnic charge, a bottle of carbon dioxide. When the pyrotechnic charge is electrically energzd, it explodes and the percussion pin perforates the diaphragm of the CO₂ bottle. The gas pressurizes the cell box and causes the exingushig substance to flow out through a hose at the end of which a nozzle is disposed that sprinkles the extinguishing substance through a circular crown. The fire extinguisher has two small pipes within the cell box which mix CO₂ with the extinguishing substance.

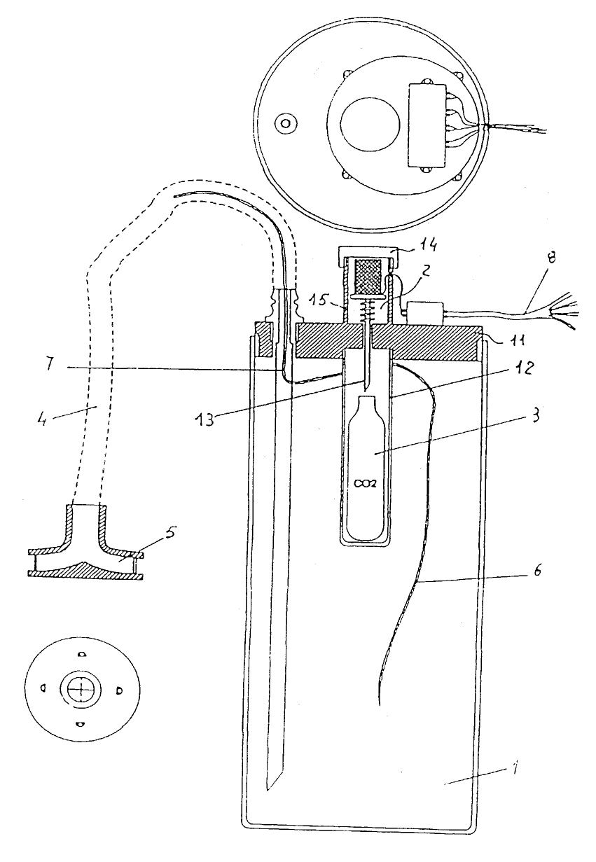

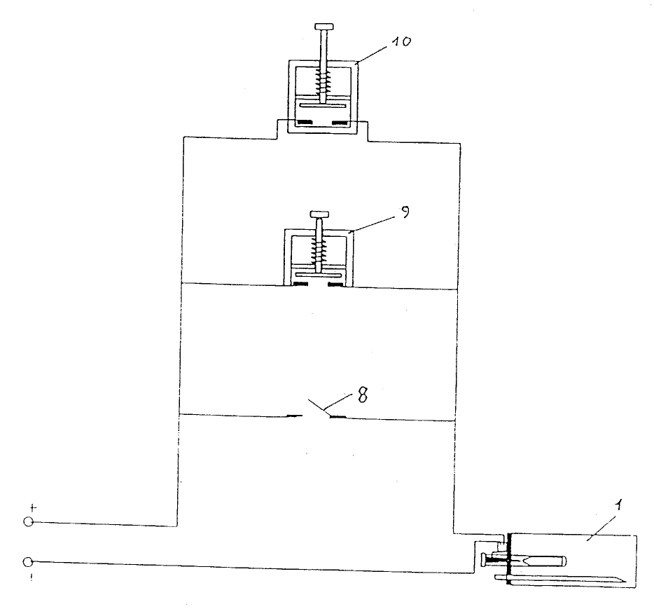

### STATE OF ART

Patents EP 1013308 A, JP62-234766 A and DE 2701935 A provide a pyrotechnic charge to break a membrane and to release an extinguishing agent under pressure. Patent EP 1013308 A is manually operated and must be placed outside the compartment to be protected against fire. Patent JP62-234766 A has a punctiform sensor on the head of the fire extinguisher that should be reached by fire to be activated so that it must be placed inside the compartment to be protected against fire. Patent DE 2701935 A has no automatic control device. These Patents provide the expansion of the gas developed by the pyrotechnic charge in a chamber that once pressurized causes the punch to move against a membrane. None of these Patents is able to detect and to extinguish a fire that develops in any point of the compartment to be protected against fire as there is not provided any suitable sensor to control the space. The state of art in this field provides manual fire extinguishers and automatic installations. The extinguishers may be of several types: dust-, CO₂-, foam-, halons-extinguishers and the like. They may be pressurized or have a CO₂ or nitrogen bottle, but they always are -operated manually. A particular type of fire extinguishers carries a sprinkler head instead of a valve assembly which explodes at a given temperature and opens the orifice from which the extinguishing substance flows out. Such a type of fire extinguisher cannot be remote controlled by any push button and/or switch and has to be installed directly in the apparatus to be protected.

The automatic fire extinguishing installations consist of a sensor device and an extinguishing device. The fire is sensed by field sensors connected to a sensing and extinguishing central installation.

The automatic fire extinguisher of the present invention is located in the middle between the manual fire extinguisher and the automatic fire extinguishing installation and is absolutely new. It is easy to be operated like the manual extinguishers and has the advantages of the known automatic fire-extinguishing installations.

The automatic, pyrotechnic fire extinguisher of the present invention (Tab. 1/2) consists of a cell box (1) containing the extinguishing substance, a valve assembly (2), a pyrotechnic charge, a bottle of liquid carbon dioxide (3), a hose (4) for supplying the extinguishing substance, a nozzle (5), two small pipes (6) and (7) within the cell box, a thermosensitive cable (8), a manually controlled electrical push button (9), a percussion pin switch (10).

The valve assembly consists of: a cylindrical threaded body (11) which is screwed to the cell box; a bottle holder (12); a percussion pin (13); a plug (14) which closes the chamber (15) acting as mortar in which the pyrotechnic charge is received.

In case of fire, when the pyrotechnic charge is electrically energized by the thermosensitive cable (8), it explodes and causes the percussion pin to perforate the diaphragm of the carbon dioxide bottle (3). The propellant contained in the bottle enters the cell box (1) and pressurizes the extinguishing substance causing the same to flow out under pressure. At the same time, CO₂ flows into pipes (6) and (7). The portion of CO₂ flowing through pipe (6) causes the extinguishing substance to swirl, while the portion flowing through pipe (7) is discharged directly to the hose where it mixes in a swirling way with the flow of the extinguishing substance. Pipe (7) is basic for the foaming.

The fire extinguisher (Tab. 2/2) may be controlled:

1) manually, by an electric push button (16) located, for example, in the interior compartment of an automotive vehicle near the driver;

2) automatically, in case of fire, by the action of the heat that shorts the thermosensitive cable (8) located above the area to be protected; e.g., in case of an automotive vehicle the cable is located under the hood panel;

3) automatically, in case of front impact, by the action of the percussion pin switch (10) located between bumper and engine.

The fire extinguisher may be located within the engine compartment in a vertical or horizontal position or within another room available in the automotive vehicle or the apparatus to be protected.

The automatic fire extinguisher can protect automotive vehicles, boats, electrical, electronic, thermal, oleodynamic apparatus, generating sets etc., and is particularly suitable for unmanned apparatus and rooms.

1. A fire extinguisher for car compartments, boats, electrical, mechanical apparatus contained in cabinets and/or closed rooms, that is automatically and manually activated and can be placed inside or outside the compartment to be protected against fire.

2. The fire extinguisher of claim 1, characterized by an electrically operated pyrotechnic charge which rests directly on the percussion pin.

3. The fire extinguisher of claim 1, characterized in that it has a thermosensitive cable sensor which is short circuited by the heat of the fire and ignites directly the pyrotechnic charge without the need of any fire fighting control panel.

4. The fire extinguisher of claim 1, characterized in that it has inside pipes that inject the gas propellant into the mass of the extinguishing agent and mix them by turbulence.
